(19) United States
(12) Patent Application Publication
(10) Pub. No.: US 2005/0086308 A1
(43) Pub. Date: Apr. 21, 2005

(54) Method and apparatus for obtaining rapid approval of a request

(76) Inventor: Ching Hoe Lee, Ipoh (MY)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/665,851

(22) Filed: Sep. 18, 2003

(51) Int. Cl. G06F 15/16; G06F 15/173

(52) U.S. Cl. 709/206; 709/239

(57) ABSTRACT

In one embodiment, a method is provided. The method comprises receiving a message from a first user to a second user, wherein the message originates at a first node in a network, is addressed to a second node in the network, and includes a request for input from the second user; sending the message to the second node; and if no indication is received to indicate that the second user has read the message, then sending the message to a target device associated with the second user, the target device not being connected to the network.

### FIELD OF THE INVENTION

This invention relates to electronic messaging. In particular, the invention relates to a method and apparatus for obtaining rapid approval of an electronic message containing a request.

### BACKGROUND

Using an electronic messaging system, it is possible for people to communicate by sending and receiving electronic mail (email) messages. To send an email message, a sender composes the content of the message using electronic messaging software, enters or selects the email address of a recipient of the email message, and dispatches the email to a mail server that routes the message to a storage area or mailbox associated with the recipient. The recipient accesses the message from the mailbox using electronic mail software.

In reaching the mailbox of the recipient, the electronic mail message may travel through a single network or through a plurality of intermediate networks. Depending on the traffic of the single or intermediate networks, the email message may be delivered to the mailbox almost immediately after it is sent. This speed of delivery makes email messages particularly attractive in comparison to paper-based mail.

Sometimes a document that is sent electronically, as described above, requires immediate input or feedback from the recipient. For example, the document may contain a request for approval from an employee to a supervisor/approver. However, the supervisor may not be logged into the system that contains his/her mailbox and would therefore be unaware that a message has been received that requires an urgent response. In this case, the email message may remain in the mailbox for hours, days, or even weeks until the supervisor logs into the system and checks his/her mailbox.

In cases where urgent input or feedback to an email message is required, it is desirable to get the message to the recipient in a timely fashion even if the recipient is not currently logged into the system that has his/her mailbox.

### BRIEF DESCRIPTION OF THE DRAWINGS

FIG. 1 shows a block diagram of an electronic mail messaging system in the form of a document approval system, in accordance with the prior art;

FIG. 2 shows a typical interaction that occurs using the document approval system of FIG. 1;

FIG. 3 shows an example of the document that requires urgent input/feedback, the document being in the form of a request for approval;

FIG. 4 shows a flowchart of operations performed by a document approval system in accordance with one embodiment of the invention;

FIG. 5 shows operations performed on the document of FIG. 4, in accordance with one embodiment;

FIG. 6 illustrates an authentication procedure, in accordance with one embodiment of the invention;

FIG. 7 shows a typical response to the document of FIG. 4; and

FIG. 8 shows a block diagram of the components of a document approval system, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

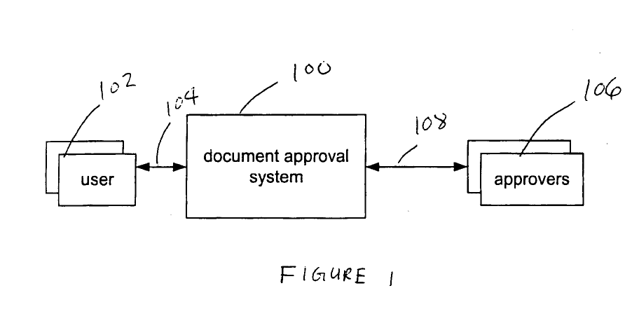

FIG. 1 shows a block diagram of an electronic mail messaging system in the form of a document approval system 100. One or more users 102 may establish a connection 104 with the document approval system 100 whereby electronic messages may be sent to and received from the system 100. Similarly, one or more approvers 106 may establish a connection 108 with the document approval system 100 whereby electronic messages may be sent to the system 100 or received therefrom. The connections 104, 108 may be established using a variety of techniques or components. For example, connections 104, 108 may be established using a local area network (LAN), or a wide-area network (WAN), for example, in the form of the Internet.

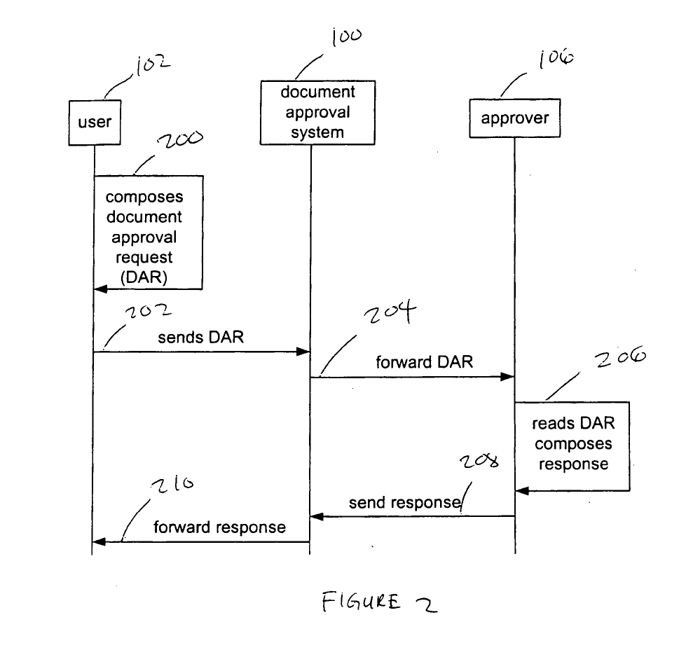

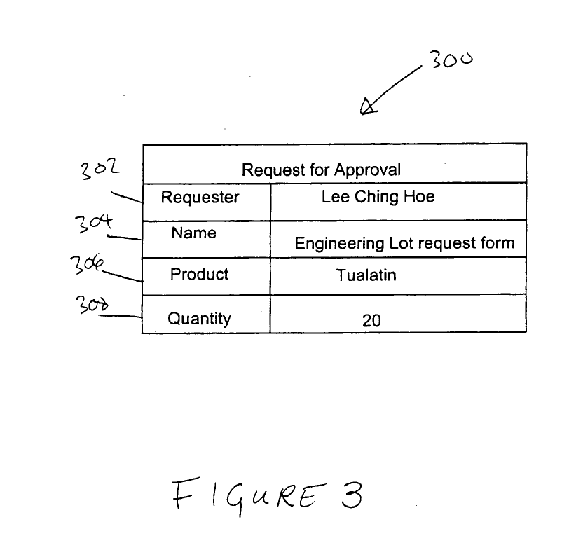

Referring now to FIG. 2 of the drawings, a typical interaction between the user 102, the document approval system 100, and the approver 106, in accordance with the prior art is shown. Starting at 200, the user 102 composes a document in the form of an email message that requires immediate approval or feedback from the recipient of the document. For the purposes of this description, the document composed at 200 is a document approval request (DAR). One example of such a DAR includes the “Request for Approval” document 300 shown in FIG. 3 of the drawings. Referring to FIG. 3, it can be seen that the request for approval document 300 includes a requestor field 302, a name field 304, a product field 306, and a quantity field 308. In this particular example, the person requesting approval is “Lee Ching Hoe.” The title or name of the document is “Engineering Lock Request Form.” The product being requested is Tualatin, and the quantity of Tualatin being requested is 20.

Referring again to FIG. 2 of the drawings, at 202, the DAR is sent to the document approval system 100. At 204, the system 100 forwards the DAR to the approver 106 who is indicated as the recipient of the DAR. At 206, the approver 206 reads the DAR and composes a response thereto. The response may take the form of an approval or a denial of the request for approval. Thereafter at 208, the approver 106 sends the response to the document approval system 100, which then forwards the response at 210 to the user 102. As noted above, if the approver 106 is not currently logged into the system 100, he/she will be unaware that the DAR has been received and requires urgent approval.

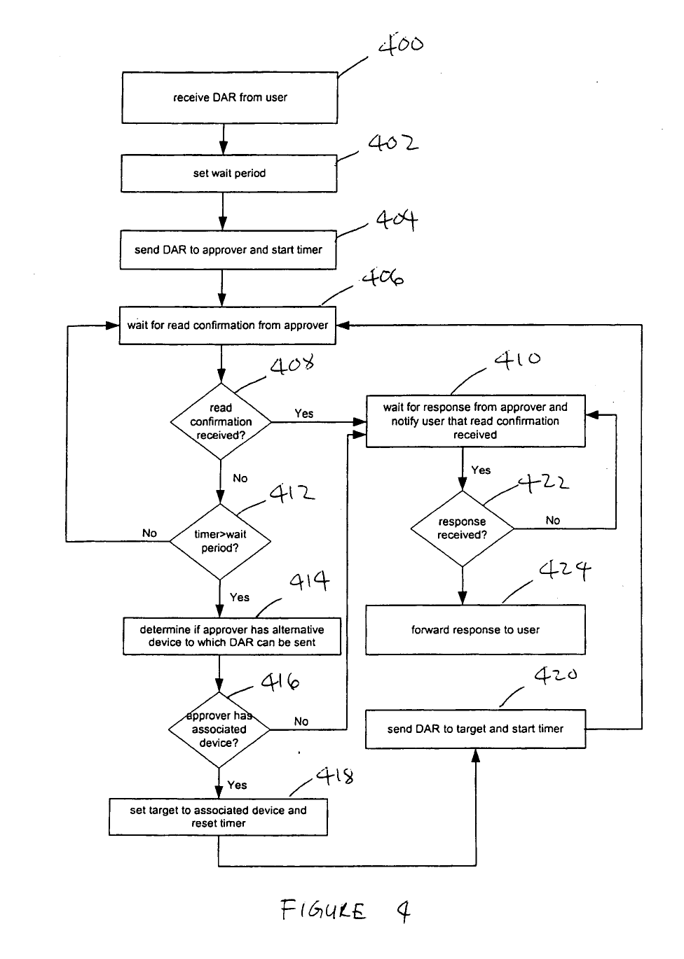

In order to ensure rapid approval of the DAR, in one embodiment, the system 100 includes functionality to perform the method illustrated in FIG. 4 of the drawings. Referring to FIG. 4, at block 400, the system 100 receives the DAR from the user 102. At block 402, the system 100 sets a wait period which is the time period for which the system 100 will wait for the approver 106 to respond to the DAR, before taking further action. In one embodiment, the wait period is set based upon how urgently feedback or a response to the DAR is required from the approver 106. In one embodiment, the DAR may include a field that indicates how urgently the response is required. For example, an urgency field may be included in the DAR that specifies how urgently a response is required in terms of time. In this embodiment, the system 100 sets the wait period based on the urgency field.

Thereafter at 404, the system 100 sends the DAR to the approver 106 and starts a timer. At 406, the system 100 waits for an indication in the form of a read confirmation that indicates that the approver 106 has read the DAR. At 408, the system 100 checks that the read confirmation has been received. If the read confirmation has been received, then at 410 the system 100 waits for a response from the approver 106, and notifies the user 102 that the read confirmation has been received from the approver 106. If at 408, the system 100 determines that no read confirmation has been received from the approver 106, then at 412, the system 100 checks if the wait period has expired. If the wait period has not expired, then control passes to block 406, otherwise, block 414 executes wherein the system 100 determines if the approver 106 has an associated device to which the DAR can be sent.

In one embodiment, the system 100 allows each approval 106 to enter one or more associated devices to which the DAR may be sent. For example, approver 106 may enter an associated Personal Digital Assistant (pda), or a mobile phone as associated devices to which the DAR should be sent. If at 416, the system 100 determines that the approver 106 does not have an associated device then control passes to block 410, otherwise control passes to block 418 where the associated device is set as a target and the timer is reset. At block 420, the system sends the DAR to the target and starts the timer. From block 420, control passes to block 406.

If at block 416, the system 100 determines that the approver 106 has no associated device, then control passes to block 410. After execution of block 410, block 422 executes, wherein the system 100 determines if a response to the DAR has been received. If no response has been received then control passes to block 410, otherwise control passes to block 424, wherein the response is forwarded to the user 102.

In a case where the approver 106 has more than one associated device, block 418 may be modified so that upon the first execution of block 418, the target is set to the first device from the list, upon the second execution of block 418, the target is set to the second device in the list, and so on until the DAR has been sent to each device in the list or until one of the devices sends either a read confirmation, or a response to the system 100

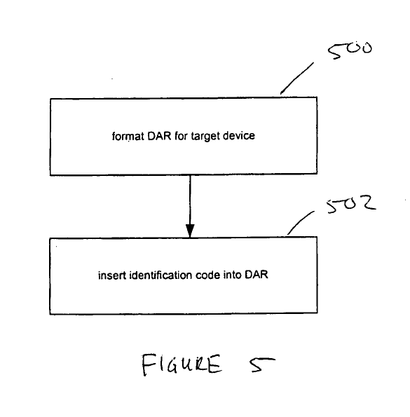

In one embodiment, the system 100 performs the operations shown in FIG. 5 of the drawings. Referring to FIG. 5, at block 500, the system 100 formats the DAR for the target device. In accordance with one embodiment, this formatting is in accordance with the capabilities of the device. For example, the target device may have a color display screen or may have a certain screen size. In this example formatting the DAR may include formatting it to take into account the screen size and the color capabilities of the target device. At block 502, the system 100 inserts a document identifier into the DAR. This document identifier is used to map the responses received from the approver 106 to specific DARs. Thus, instead of the approver 106 sending the entire request back to the system 100 as part of the approver's response to the DAR, the approver 106 may send a document containing only the document id and the approval status, i.e., whether the approval is approved, rejected, or on-hold, etc. This conserves delete space band-width since a response with only a document identifier requires less bytes to transmit than a response that includes the entire DAR itself.

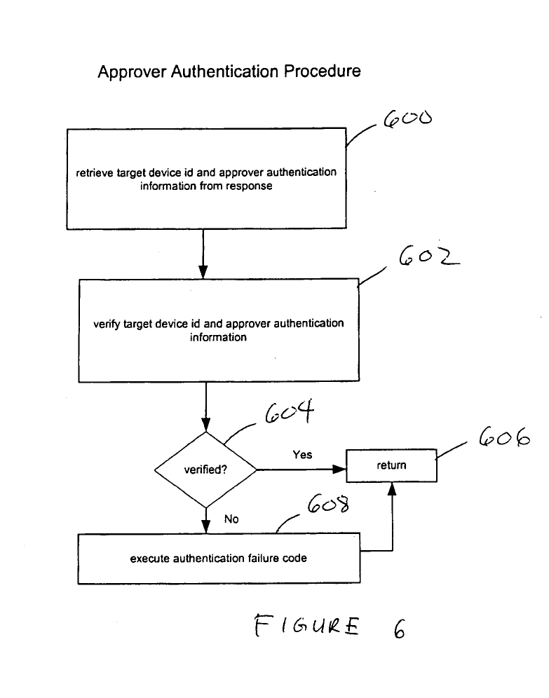

In one embodiment, the system 100 performs the approval authentication procedure shown in FIG. 6 of the drawings, after receiving a response from the approver 106. Referring to FIG. 6, at block 600, the system 100 retrieves a target device identifier (id) which typically is embedded within a response received from the approval 106. A target device id identifies the target device used by the approval 106 to send a response. At 600, the system 100 also retrieves approval authentication information from the response. Typically, the approval authentication information may be in the form of a pass code assigned to the approver 106 by the system. At block 602, the system 100 verifies the target device id and the approval authentication information using stored records. At block 604, if the target device id and the approval authentication information is verified, then at block 606, the approval authentication procedure terminates, otherwise block 608 executes wherein authentication failure code is executed. In one embodiment, the authentication failure code includes a procedure to notify the user 102 that the DAR has been received by an unauthenticated third party.

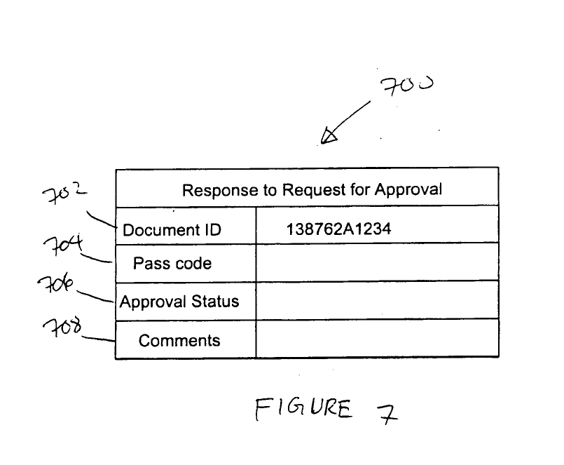

FIG. 7 shows a response 700 to the DAR, in accordance with one embodiment. As will be seen, the response 700 includes a document id 702, a pass code 704, an approval status field 706 in the approval may indicate whether the request is approved, denied or on-hold, etc., and optionally a comments field 708 where the approver 106 may include additional comments or send a counter proposal to the DAR.

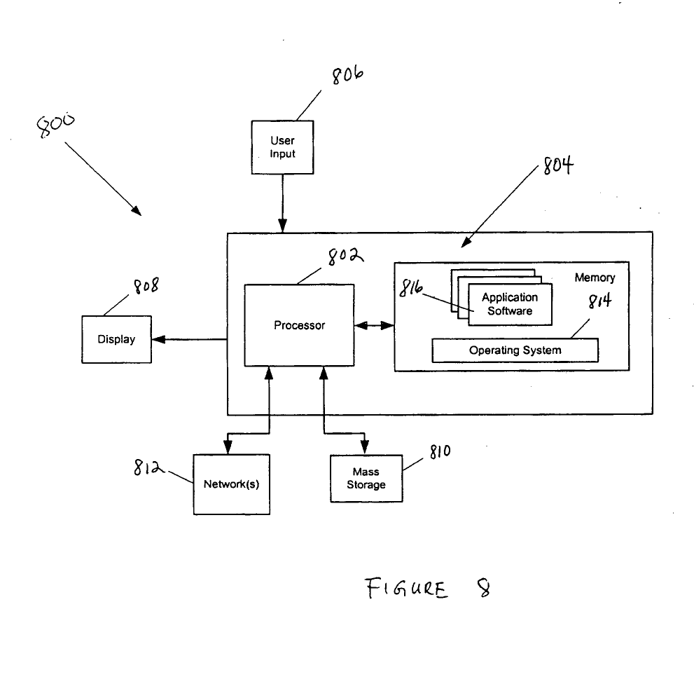

Referring to FIG. 8 of the drawings, reference numeral 800 generally indicates hardware that may be used to implement the system 100, in accordance with one embodiment. The hardware 800 typically includes at least one processor 802 coupled to a memory 804. The processor 802 may represent one or more processors (e.g., microprocessors), and the memory 804 may represent random access memory (RAM) devices comprising a main storage of the hardware 800, as well as any supplemental levels of memory e.g., cache memories, non-volatile or back-up memories (e.g. programmable or flash memories), read-only memories, etc. In addition, the memory 804 may be considered to include memory storage physically located elsewhere in the hardware 800, e.g. any cache memory in the processor 802, as well as any storage capacity used as a virtual memory, e.g., as stored on a mass storage device 810.

The hardware 800 also typically receives a number of inputs and outputs for communicating information externally. For interface with a user or operator, the hardware 800 may include one or more user input devices 806 (e.g., a keyboard, a mouse, etc.) and a display 808 (e.g., a Cathode Ray Tube (CRT) monitor, a Liquid Crystal Display (LCD) panel).

For additional storage, the hardware 800 may also include one or more mass storage devices 810, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 800 may include an interface with one or more networks 812 (e.g., a local area network (LAN), a wide area network (WAN), a wireless network, and/or the Internet among others) to permit the communication of information with other computers coupled to the networks. It should be appreciated that the hardware 800 typically includes suitable analog and/or digital interfaces between the processor 802 and each of the components 804, 806, 808 and 812 as is well known in the art.

The hardware 800 operates under the control of an operating system 814, and executes various computer software applications, components, programs, objects, modules, etc. (e.g. a program or module which performs operations as shown in FIGS. 4 to 6 of the drawings). Moreover, various applications, components, programs, objects, etc. may also execute on one or more processors in another computer coupled to the hardware 800 via a network 812, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of form, and that the invention applies equally regardless of the particular type of signal bearing media used to actually off the distribution. Examples of signal bearing media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

1. A method, comprising:
receiving a message from a first user to a second user, wherein the message originates at a first node in a network, is addressed to a second node in the network, and includes a request for input from the second user;
sending the message to the second node; and
if no indication is received to indicate that the second user has read the message, then sending the message to a target device associated with the second user, the target device not being connected to the network.

2. The method of claim 1, further comprising associating at least one target device with the second user.

3. The method of claim 2, wherein sending the message to the target device comprises sending the message sequentially to each target device in the list.

4. The method of claim 3, wherein sending the message sequentially to each target device in the list comprises setting the first target device in the list as a current device and repeating:
sending the message to the current device; and
setting the next target device on the list as the current device if no indication is received from the current device to indicate that the second user has read the message;
until the message has been sent to all target devices in the list.

5. The method of claim 1, wherein sending the message to the target device comprises first determining if the second user has any associated target devices.

6. The method of claim 1, further comprising waiting a time period before sending the message to the target device.

7. The method of claim 1, further comprising determining the time period based on an urgency of the message.

8. The method of claim 1, further comprising receiving a response from the second user, and sending the response to the first user.

9. The method of claim 1, wherein the message comprising an approval request, and the input from the second user comprises a response to the approval request.

10. The method of claim 1, further comprising sending a notification to the first user if an indication is received to indicate that the second user has read the message.

11. The method of claim 1, further comprising waiting for a response from the second user if an indication is received to indicate that the second user has read the message.

12. The method of claim 1, further comprising formatting the message for the target device based on the capabilities of the target device, before sending a message.

13. A computer-readable medium having stored thereon a sequence of instructions which when executed by a processor, cause the processor to perform a method comprising:
receiving a message from a first user to a second user, wherein the message originates at a first node in a network, is addressed to a second node in the network, and includes a request for input from the second user;
sending the message to the second node; and
if no indication is received to indicate that the second user has read the message, then sending the message to a target device associated with the second user, the target device not being connected to the network.

14. The computer-readable medium of claim 13, wherein the method further comprises associating at least target device with the second user.

15. The computer-readable medium of claim 14, wherein sending a message to the target device comprises sending a message sequentially to each target device in the list.

16. The computer-readable medium of claim 15, wherein sending a message sequentially to each target device in the list comprises setting the first target device in the list as a current device and
repeating:
sending the message to the current device; and
setting the next target device on the list as the current device if no indication is received from the current device to indicate that the second user has read the message;
until the message has been sent to all target devices in the list.

17. The computer-readable medium of claim 13, wherein sending a message to the target device comprises first determining if the second user has any associated target devices.

18. The computer-readable medium of claim 13, wherein the method further comprises waiting a time period before sending the message to the target device.

19. The computer-readable medium of claim 13, wherein the method further comprises determining the time period based on an urgency of the message.

20. A system, comprising:
a processor;
a network card coupled to the processor to enable communications with one of more networks; and
a memory coupled to the processor, the memory storing instructions which when executed by the processor, cause the system to perform a method comprising:
receiving a message from a first user to a second user, wherein the message originates at a first node in a network, is addressed to a second node in the network, and includes a request for input from the second user;
sending the message to the second node; and
if no indication is received to indicate that the second user has read the message, then sending the message to a target device associated with the second user, the target device not being connected to the network.

21. The system of claim 20, wherein the method further comprises associating at least one target device with the second user.

22. The system of claim 21, wherein sending the message to the target device comprises sending the message sequentially to each target device in the list.

23. The system of claim 22, wherein sending the message sequentially to each target device in the list comprises setting the first target device in the list as a current device and
repeating:
sending the message to the current device; and
setting the next target device on the list as the current device if no indication is received from the current device to indicate that the second user has read the message;
until the message has been sent to all target devices in the list.

24. The system of claim 20, wherein sending the message to the target device comprises first determining if the second user has any associated target devices.

25. The system of claim 20, wherein the method further comprises waiting a time period before sending the message to the target device.

26. The system of claim 20, wherein the method further comprises determining the time period based on an urgency of the message.

27. The system of claim 20, wherein the method further comprises receiving a response from the second user, and sending the response to the first user.

28. The system of claim 20, wherein the message comprises an approval request, and the input from the second user comprises a response to the approval request.

29. The system of claim 20, wherein the method further comprises sending a notification to the first user if an indication is received to indicate that the second user has read the message.

30. The system of claim 20, wherein the method further comprises inserting a document identifier into a message before sending it to the target device.
